(19) United States
(12) Patent Application Publication
(10) Pub. No.: US 2025/0390309 A1
(43) Pub. Date: Dec. 25, 2025

(54) TECHNIQUE FOR GENERATING PREDICTIONS OF A TARGET ADDRESS OF BRANCH INSTRUCTIONS

(71) Applicant: Arm Limited, Cambridge (GB)

(72) Inventors: James David DUNDAS, Austin, TX (US); Houdhaifa BOUZGUARROU, Austin, TX (US); Michael Brian SCHINZLER, Round Rock, TX (US); Sergio SCHULER, Austin, TX (US)

(21) Appl. No.: 18/753,513

(22) Filed: Jun. 25, 2024

(51) Int. Cl. G06F 9/38; G06F 9/32

(52) U.S. Cl. CPC G06F 9/3844; G06F 9/321; G06F 9/3806

(57) ABSTRACT

An apparatus, and corresponding method, is provided, the apparatus comprising default prediction circuitry, responsive to an address associated with a given branch instruction, to generate a default prediction of a target address for the given branch instruction, and further prediction circuitry arranged, when the given branch instruction is a given type of branch instruction, to generate a further prediction of the target address for the given branch instruction. The further prediction is generated later than the default prediction and is used in place of the default prediction in the event that the further prediction differs from the default prediction. Monitoring circuitry is arranged, responsive to detecting an update condition based on monitoring an observed indication of the target address for multiple occurrences of the given branch instruction, to cause the default prediction circuitry to be updated so as to alter the default prediction generated by the default prediction circuitry for the given branch instruction.

### BACKGROUND

The present technique relates to the field of data processing. More particularly, it relates to branch prediction.

A data processing apparatus may have a branch predictor for predicting outcomes of branch instructions. This can help to improve performance by allowing subsequent instructions beyond the branch to be fetched for decoding and execution before the actual outcome of the branch is determined.

One form of outcome of a branch instruction which may be predicted using a branch predictor is the target address of that branch instruction. When a branch instruction is executed, this will either cause a branch to be taken or not taken. If the branch is not taken, then execution merely proceeds to the next sequential instruction following the branch instruction. However, if the branch is taken, then the instruction flow proceeds to the above-mentioned target address, such that the next instruction executed is the instruction at that target address. It will hence be appreciated that if the target address can be accurately predicted, this can significantly improve performance, by allowing the appropriate sequence of instructions to be fetched and decoded when it is predicted that execution of the branch instruction in due course will result in the branch been taken.

However, for certain types of branch instruction, there can be a significant latency incurred in the prediction of the target address, which can limit the performance benefits potentially available from the use of such target address prediction, and it would hence be desirable to reduce that latency.

### SUMMARY

In accordance with a first example arrangement, there is provided an apparatus comprising: default prediction circuitry, responsive to an address associated with a given branch instruction, to generate a default prediction of a target address for the given branch instruction; further prediction circuitry arranged, when the given branch instruction is a given type of branch instruction, to generate a further prediction of the target address for the given branch instruction, wherein the further prediction is generated later than the default prediction and is used in place of the default prediction in the event that the further prediction differs from the default prediction; and monitoring circuitry responsive to detecting an update condition based on monitoring an observed indication of the target address for multiple occurrences of the given branch instruction, to cause the default prediction circuitry to be updated so as to alter the default prediction generated by the default prediction circuitry for the given branch instruction.

In accordance with another example arrangement, there is provided a method of generating predictions of a target address of branch instructions, comprising: responsive to an address associated with a given branch instruction, generating using default prediction circuitry a default prediction of a target address for the given branch instruction; when the given branch instruction is a given type of branch instruction, generating using further prediction circuitry a further prediction of the target address for the given branch instruction, wherein the further prediction is generated later than the default prediction and is used in place of the default prediction in the event that the further prediction differs from the default prediction; and responsive to detecting an update condition based on monitoring an observed indication of the target address for multiple occurrences of the given branch instruction, causing the default prediction circuitry to be updated so as to alter the default prediction generated by the default prediction circuitry for the given branch instruction.

In accordance with a still further example arrangement, there is provided a system comprising: an apparatus in accordance with the first example arrangement discussed above, implemented in at least one packaged chip; at least one system component; and a board, wherein the at least one packaged chip and the at least one system component are assembled on the board. In an additional example arrangement, the above-mentioned system may be assembled on a further board with at least one other product component.

In a yet further example arrangement, there is provided a computer-readable medium storing computer-readable code for fabrication of an apparatus in accordance with the first example arrangement discussed above. The computer-readable medium may be a transitory computer-readable medium (such as wired or wireless transmission of code over a network) or a non-transitory computer-readable medium such as semiconductor, magnetic disk, or optical disc.

### BRIEF DESCRIPTION OF THE DRAWINGS

Further aspects, features and advantages of the present technique will be apparent from the following description of examples, which is to be read in conjunction with the accompanying drawings, in which:

FIG. 1 is a block diagram schematically illustrating a data processing system in which the branch prediction techniques described herein may be employed, in accordance with one example implementation;

FIG. 2 illustrates default prediction circuitry that may be used to predict a target address for a branch instruction, in accordance with one example implementation;

FIG. 3 illustrates an example of history information;

FIG. 4 illustrates further prediction circuitry that can be used to predict a target address for at least one type of branch instruction, with reference to program flow history of a program executed by the data processing system, in accordance with one example implementation;

FIGS. 5A and 5B illustrate two example implementations of the use of monitoring circuitry to determine when to update the default prediction generated by the default prediction circuitry for a given branch instruction;

FIG. 6 schematically illustrates the monitoring circuitry in accordance with one example implementation;

FIG. 7 is a flow diagram illustrating how the monitoring circuitry of FIG. 6 operates, in accordance with one example implementation;

FIG. 8 schematically illustrates the monitoring circuitry in accordance with an alternative example implementation;

FIG. 9 is a flow diagram illustrating how the monitoring circuitry of FIG. 8 operates, in accordance with one example implementation;

FIGS. 10A and 10B are flow diagrams illustrating how replacement metadata within an entry of the monitoring circuitry may be updated, in accordance with one example implementation;

FIG. 11 is a flow diagram illustrating an example replacement policy that may be employed by the monitoring circuitry, in accordance with one example implementation; and

FIG. 12 illustrates a system and a chip-containing product.

### DESCRIPTION OF EXAMPLES

In accordance with the techniques described herein, an apparatus may be provided that has default prediction circuitry arranged, responsive to an address associated with a given branch instruction, to generate a default prediction of a target address for the given branch instruction. The address associated with the given branch instruction can take a variety of forms. Whilst in one example implementation it could be the actual address of the given branch instruction itself, in another example implementation the default prediction circuitry may be arranged to review instructions in blocks, with each block comprising multiple instructions. In such an implementation the default prediction circuitry may seek to provide a prediction of the target address for one or more branch instructions within that block of instructions, and in that case the address associated with the given branch instruction may be the address identifying the block of instructions (for example the address of the first instruction in the block).

Whilst the default prediction circuitry may work well for many branch instructions, there are certain branch instructions for which the default prediction circuitry may not provide accurate predictions. For instance, there may be many paths (program flows) that could be taken through a program, dependent for example on the taken/not taken behaviour of the various branch instructions encountered within that program. If the target address of a certain branch instruction does not vary in dependence on the program flow history of the program, then the default prediction circuitry may be able to be trained to provide an accurate prediction of the target address of that branch instruction. However, for certain types of branch instruction, for example branch instructions whose target address does vary in dependence on the program flow history (which may be referred to herein as polymorphic branch instructions), the default prediction circuitry may be unable to provide a reliable prediction of the target address.

Hence, the apparatus may have further prediction circuitry that is arranged, when the given branch instruction is a given type of branch instruction, to generate a further prediction of the target address for the given branch instruction. The aim of the further prediction circuitry is to provide a prediction of the target address of a branch instruction for which the default prediction circuitry may struggle to provide an accurate prediction. However, it is often the case that the further prediction circuitry will take longer to generate a predicted target address than the default prediction circuitry. For instance, the further prediction generated by the further prediction circuitry may only be available one or more clock cycles later than the default prediction made by the default prediction circuitry.

In one example implementation, the default prediction may be used until the further prediction is available, with the further prediction then being used in place of the default prediction in the event that the further prediction differs from the default prediction. In the event that the default prediction matches the further prediction, then this can in that instance hide the latency associated with the generation of the further prediction, and hence improve performance. However, when the further prediction differs from the default prediction, the latency associated with the generation of the further prediction can impact performance. This can also give rise to potential pipeline bubbles arising where the processing pipeline is not full, for example due to any instructions fetched based on the default prediction having to be flushed from the pipeline and replaced with instructions fetched based on the further prediction, and such pipeline bubbles are likely to adversely affect throughput, and thus performance.

One potential way to seek to reduce the latency associated with the generation of the further prediction might be to seek to update the default prediction that will be made by the default prediction circuitry each time the further prediction circuitry is trained based on an observed target address of the branch instruction of the given type, so as to seek to improve the likelihood that the default prediction will match the further prediction, and hence hide the latency associated with making the further prediction. However, such an approach would come at a high power cost due to the need to update the default prediction circuitry on each training event of the further prediction circuitry. Such an approach can also cause read/write conflicts with ongoing predictions, which could reduce performance by injecting stalls into the prediction pipeline.

In accordance with the techniques described herein, the above issues are alleviated by providing monitoring circuitry that is responsive to detecting an update condition based on monitoring an observed indication of the target address for multiple occurrences of the given branch instruction, to cause the default prediction circuitry to be updated so as to alter the default prediction generated by the default prediction circuitry for the given branch instruction. Hence, the monitoring circuitry is arranged to observe an indication of the target address for multiple occurrences of the given branch instruction in order to seek to detect scenarios where updating of the default prediction made by the default prediction circuitry may be useful, e.g. where it is considered that, based on the indications of the target address observed for those multiple instances, performance is likely to be improved by updating the default prediction made by the default prediction circuitry. It has been found that such an approach can produce similar performance gains to an approach of updating the default target on every training event of the further prediction circuitry, whilst eliminating a large number of the write operations to the default prediction circuitry that would otherwise be required were the default target updated on every training event of the further prediction circuitry. Such an approach can hence both improve performance and reduce power consumption.

The timing at which the default prediction circuitry is caused to be updated once the update condition has been detected may vary dependent on implementation. For instance, detection of the update condition may trigger the default prediction circuitry to be updated straight away, or the next time the given branch instruction is observed (for example the next time that the given branch instruction is executed, the next time the further prediction circuitry is trained based on the actual target address determined from execution of the given branch instruction, etc.). In some example implementations, once the update condition has been detected, this may cause a single update to the default prediction and then some form of reset of the monitoring circuitry so that further monitoring of the observed indication of the target address for additional occurrences of the given branch instruction will be required before the update condition can again be detected. However, in alternative implementations, the update condition may be considered to persist for a period of time, and updates to the default prediction may be periodically made whilst the update condition is considered still to be present, for example whenever the currently observed indication of the target address by the monitoring circuitry differs from the previously observed indication of the target address, or at a given frequency, for example every 16 or 32 executions of the given branch instruction.

The further prediction circuitry can take a variety of forms, but in one example implementation is a history-dependent prediction circuitry that is arranged to generate the further prediction in dependence on a program flow history of a program executed by processing circuitry. In one such implementation, the given type of branch instruction may be a polymorphic branch instruction whose target address varies in dependence on the program flow history. It has been found that when employing the techniques described herein within such an implementation, significant improvements in performance and reductions in power consumption can be achieved.

There are various ways in which the monitoring circuitry may be arranged to detect the update condition. However, in one example implementation, the monitoring circuitry is arranged to detect the update condition based on performance of a probabilistic test to assess, given the observed indication of the target address for multiple occurrences of the given branch instruction, whether an update of the default prediction is expected to improve accuracy of the default prediction. There are a number of ways in which an update of the default prediction may improve the accuracy of the default prediction. For instance such an update may result in the default prediction of the target address for the given branch instruction being more likely to match the actual target address observed when that given branch instruction is next executed, or the outcome of that execution is committed. As another example, such an update may result in the default prediction of the target address for the given branch instruction being more likely to match the further prediction generated by the further prediction circuitry.

The probabilistic test performed by the monitoring circuitry can take a variety of forms. For example, any suitable technique could be used to seek to assess, based on the pattern of target addresses observed over multiple occurrences, whether an update of the default prediction might improve accuracy. Purely by way of illustrative example, where there is some locality within a program's execution for a certain period of time, this may give rise to the same target address being observed over multiple occurrences of the given branch instruction, and detection of this (at least temporal) stability in the observed target address may indicate that it would be useful to update the default target address if the default target address is different to that observed target address. As another example, if target addresses different from the default target address are observed for multiple occurrences of the given branch instruction, this may indicate that the default target address is not proving to be useful, and hence it may be beneficial to update the default target address.

In one example implementation the monitoring circuitry is arranged to maintain a test counter for the given branch instruction which is referred to when performing the probabilistic test. In particular, the value of that test counter may be altered in dependence on the observed indication of the target address for multiple occurrences of the given branch instruction, and the probabilistic test may comprise determining whether the test counter has at least reached a predetermined value indicating presence of the update condition. Depending on how the test counter value is adjusted, and under what conditions, the predetermined value may represent an upper threshold such that when the counter value reaches or exceeds that threshold this indicates presence of the update condition, or the predetermined value may represent a lower threshold such that when the counter value drops to the predetermined value or lower this indicates the presence of the update condition. Further, depending on implementation, the predetermined value may represent a maximum value (in the upper threshold example) or a minimum value (in the lower threshold example), or it may be possible for the counter value to continue to be adjusted beyond the predetermined value.

There are various pieces of information that the monitoring circuitry may track in relation to the given branch instruction, in order to enable it to assess when the test counter value should be adjusted, and assess when the update condition has been detected. In one example implementation the monitoring circuitry may be arranged, for the given branch instruction, to store an indication of the default prediction of the target address generated by the default prediction circuitry, to use the test counter to track occurrences of divergence of the observed indication of the target address from the default prediction, and to detect the update condition when the test counter reaches the predetermined value indicating that a mismatch threshold has been reached. Hence, in such an implementation the monitoring circuitry can be used to seek to detect when the usefulness of the default prediction of the target address generated by the default prediction circuitry has dropped below a certain threshold, and in that event to trigger an update to the default prediction.

In one particular example implementation, each time the observed indication of the target address for an occurrence of the given branch instruction differs from the default prediction the monitoring circuitry may be arranged to increment the test counter by an increment value. Hence, in this specific example implementation the test counter value will increase over time if the observed target address continues to differ from the default prediction of the target address, with the predetermined value being a value that, when reached, indicates that it would be appropriate to seek to update the default prediction of the target address.

In one example implementation, in addition to incrementing the test counter under the condition noted above, each time the observed indication of the target address for an occurrence of the given branch instruction matches the default prediction the monitoring circuitry may be arranged to decrement the test counter by a decrement value. Whilst the increment value and the decrement value may be of the same magnitude, for example 1, this is not essential, and in some implementations it may be considered appropriate to have a decrement value that differs in magnitude from the increment value.

Whilst in the above example, the predetermined value is assumed to be an upper threshold such that when the counter value reaches or exceeds that threshold this indicates presence of the update condition, in an alternative example implementation the predetermined value may be a lower threshold such that when the counter value drops to the predetermined value or lower this indicates the presence of the update condition. In such an alternative example implementation the test counter could be initialised to a certain positive value, and then decremented towards the predetermined value each time the observed indication of the target address for an occurrence of the given branch instruction differs from the default prediction. Similarly, the test counter value could be incremented whenever there is a match between the observed indication of the target address and the default prediction.

In one example implementation, the monitoring circuitry is arranged, on determining that the mismatch threshold has been reached, to trigger an update of the default prediction circuitry such that an altered default prediction will be generated. The time at which the update of the default prediction circuitry is triggered once the mismatch threshold has been reached may vary dependent on implementation. However, in one example implementation this occurs when the given branch instruction is next executed. For example, the target address provided from the execute/commit stage of the processing pipeline as a result of that next execution of the given branch instruction may be used as the altered default prediction to be stored within the default prediction circuitry for the given branch instruction. Alternatively, when that target address from the execute/commit stage is provided to the further prediction circuitry to initiate a training operation of the further prediction circuitry, then the updated further prediction that will next be generated by the further prediction circuitry following the training operation can be provided to the default prediction circuitry as the updated default prediction.

In addition to triggering the update of the default prediction circuitry on determining that the mismatch threshold has been reached, the monitoring circuitry may also be arranged to update the stored indication of the default prediction to match the altered default prediction, to reset the test counter, and to then track occurrences of divergence of the observed indication of the target address from the altered default prediction. It is appropriate at this point to reset the test counter, as any future adjustments of the test counter value will be made taking into account the new default prediction, and hence the value of the test counter based on the old default prediction is no longer relevant.

Whilst in the above discussed example, the test counter is used to track occurrences of divergence of the observed indication of the target address from the default prediction generated by the default prediction circuitry, there are various alternative approaches that could be adopted in order to enable the monitoring circuitry to assess when the test counter value should be adjusted, and to assess when the update condition has been detected. For instance, in one example implementation, the monitoring circuitry may be arranged, for the given branch instruction, to maintain a record of a last observed indication of the target address, to use the test counter to track when a current observed indication of the target address matches the last observed indication, and to detect the update condition when the test counter at least reaches the predetermined value indicating that an update usefulness threshold has been met. If a degree of consistency is observed in the target address over multiple observed indications of the target address, as for example may occur when there is some locality within a program's execution for a certain period of time, then this relative stability in the observed target address can be used to infer that it would be useful to update the default target address. For instance, the observed consistency in the target address may indicate that the last observed indication of the target address is likely to be useful in predicting the next observed indication of the target address. Hence, by using the test counter in the above way, it can be determined when an update to the default prediction may be useful.

There are various ways in which the test counter value may be adjusted in dependence on the observed indications of the target address. For instance, in one example implementation, each time the current observed indication of the target address matches the last observed indication of the target address the monitoring circuitry may arranged to increment the test counter by an increment value. Further, in one such example implementation, each time the current observed indication of the target address differs to the last observed indication of the target address, the monitoring circuitry may be arranged to decrement the test counter by a decrement value. On occurrence of such a mismatch event, the monitoring circuitry may also be arranged to update the record of the last observed indication of the target address to indicate the current observed indication. Whilst the increment value and the decrement value may be of the same magnitude, this is not required, and in some implementations a decrement value may be chosen that is different to the increment value. Purely by way of specific example, the decrement value may be of a larger magnitude than the increment value, thus requiring multiple instances of the same target address to be observed following such a decrement before the counter again reaches the value it was previously at (i.e. the value it had at the point of the mismatch event that caused the decrement to the test counter value to be made).

In the above example implementation, the predetermined value is assumed to be an upper threshold such that when the counter value reaches or exceeds that threshold this indicates presence of the update condition. However, as discussed earlier, in an alternative example implementation the predetermined value may be a lower threshold such that when the counter value drops to the predetermined value or lower this indicates the presence of the update condition, and in that case the above-mentioned incrementing and decrementing actions will be reversed (i.e. decrementing on a match and incrementing on a mismatch).

In one example implementation, the monitoring circuitry is arranged, responsive to determining that the update usefulness threshold has been met, to cause an update of the default prediction circuitry such that an altered default prediction will be generated, and to apply an adjustment to the test counter value. The time at which the update of the default prediction circuitry is triggered once the update usefulness threshold has been reached may vary dependent on implementation. This update could for instance be triggered immediately on detecting the threshold being met, for example causing the default prediction to be updated to match the current observed indication of the target address. However, in one example implementation the update of the default prediction is triggered when an occurrence of the given branch instruction is next observed following detection of the update usefulness threshold having been met, for example the next time the given branch instruction is executed by the processing pipeline, the next time the result of execution of that given branch instruction is committed, the next time a prediction of the target address is made for that given branch instruction, etc.

There are also various ways in which the altered default prediction to be generated by the default prediction circuitry may be determined. It could for example be set based on the current observed indication of the target address as being tracked at the point the update condition was detected, or could alternatively be updated based on the next observed indication of the target address following detection of the update condition. Further, it could be set to match an actual target address determined during execution of the given branch instruction, or could be set to match a predicted value of the target address generated by the further prediction circuitry. In one example implementation, a check may be performed prior to updating the default prediction circuitry, to determine whether the altered default prediction generated in the above manner does in fact differ to the currently stored default prediction, and to only initiate the update of the default prediction circuitry if it does. Such an approach can save power consumption by avoiding any unnecessary updates.

As noted above, in one example implementation, when the update usefulness threshold is met, and an update to the default prediction is made, an adjustment is also applied to the test counter value. The adjustment made may vary dependent on implementation. For example, the adjustment may involve resetting the test counter value to an initial value, but could alternatively involve an adjustment by a predetermined amount, for example decrementing the test counter by a chosen decrement value. In one example implementation, the aim here is to adjust the counter value such that it no longer indicates presence of the update usefulness threshold (for example by reducing the counter to a point where it is then below the value needed to cause a further update of the default prediction), thus requiring further monitoring of a stable target address to take place before a further update will be triggered.

In an alternative implementation, the presence of the update usefulness threshold may not merely trigger a single update of the default prediction, and an adjustment to the test counter value, but instead periodic updates to the target address prediction may occur whilst the update condition is determined to continue to be present. In particular, in one example implementation, whilst the update condition is determined to be present, the monitoring circuitry may be arranged to implement an update procedure comprising one of:
causing the default prediction circuitry to be updated such that the default prediction is altered whenever the monitoring circuitry detects a change in the observed indication of the target address;
causing the default prediction circuitry to be updated such that the default prediction is altered once every N executions of the given branch instruction.

In one example implementation of the above approach, the value of the counter can continue to be updated (incremented and decremented) in the manner discussed earlier based on further observed indications of the target address, and the above update process can continue until such time that the counter value is adjusted to a value that no longer indicates the presence of the update condition. In one particular example implementation, no adjustment is made to the counter value each time the default prediction is updated, but in another example implementation such an adjustment could be made each time the default prediction is updated, if desired.

The observed indication of the target address that is monitored by the monitoring circuitry can take a variety of forms. For instance, in one example implementation the observed indication of the target address may be the further prediction of the target address for the given branch instruction as generated by the further prediction circuitry. However, in an alternative example implementation, the observed indication of the target address may be an actual target address for the given branch instruction when executed by processing circuitry. In this latter case, the execution of the given branch instruction by the processing circuitry that results in an observed indication of the target address being provided to the monitoring circuitry may be restricted to instances of non-speculative execution of the given branch instruction, or alternatively may include instances of speculative execution. In one particular example implementation, the generated actual target address may only be passed to the monitoring circuitry when the result of execution of the given branch instruction is committed by the processing pipeline.

The monitoring circuitry can be arranged in a variety of ways, and could for example be arranged to track a single branch instruction of the given type, or track a number of different branch instructions of the given type. In one example implementation, the monitoring circuitry is arranged to maintain one or more entries, where each entry has an identifier field used to identify a branch instruction of the given type associated with that entry (for example by identifying the address of the branch instruction being tracked by that entry), a counter field used to maintain a test counter value for the branch instruction associated with the entry, and a target address comparison field to maintain a value of the target address against which a subsequent observed indication of the target address is compared in order to determine adjustment of the test counter value. As a result, the number of branch instructions of the given type that can be monitored at any particular point in time is dependent on the number of entries provided by the monitoring circuitry.

In one example implementation, each entry may further comprise a replacement policy field used to maintain metadata used by the monitoring circuitry when implementing a replacement policy to determine when the entry is available for reallocation to another branch instruction of the given type, wherein the replacement policy is arranged to bias use of the one or more entries for monitoring of more frequently occurring branch instructions of the given type within a program flow history of a program executed by processing circuitry.

The metadata used by the monitoring circuitry when implementing the replacement policy can take a variety of forms. In one example implementation, the monitoring circuitry is arranged, for each entry, to maintain a replacement counter in the replacement policy field that is adjusted in a first direction each time the branch instruction associated with that entry is observed by the monitoring circuitry, and is adjusted in a second direction each time the monitoring circuitry, on observing a branch instruction of the given type not yet allocated to an entry of the monitoring circuitry, has no available entry to allocate for that branch instruction. Further, the monitoring circuitry is arranged to identify a given entry as an available entry for allocation when the replacement counter in the replacement policy field of that given entry has a predetermined value. By way of specific example, the replacement counter may be incremented each time the branch instruction associated with that entry is observed by the monitoring circuitry, and may be decremented each time the monitoring circuitry is unable to allocate an entry for an as yet unallocated branch instruction of the given type. In such an implementation, the predetermined value could for example be zero, and hence for the contents of an entry to be evicted (hence making room for allocation of that entry in respect of another branch instruction of the given type), that entry's replacement counter needs to be at a logic zero value.

The above is just one example of how the replacement metadata may be maintained. In another example implementation, the metadata may take the form of a branch pick counter. This could be arranged in a variety of ways, but considering by way of example monitoring circuitry that just maintains a single entry, the branch pick counter could be incremented every time the address of an observed branch instruction of the given type does not match the address of the last observed branch instruction of the given type (i.e. a different branch instruction of the given type is being observed). If the branch pick counter saturates, then all of the state of that entry may be reset, and the entry may then be re-used to begin monitoring the most recently observed branch instruction of the given type.

Particular examples will now be described with reference to the figures.

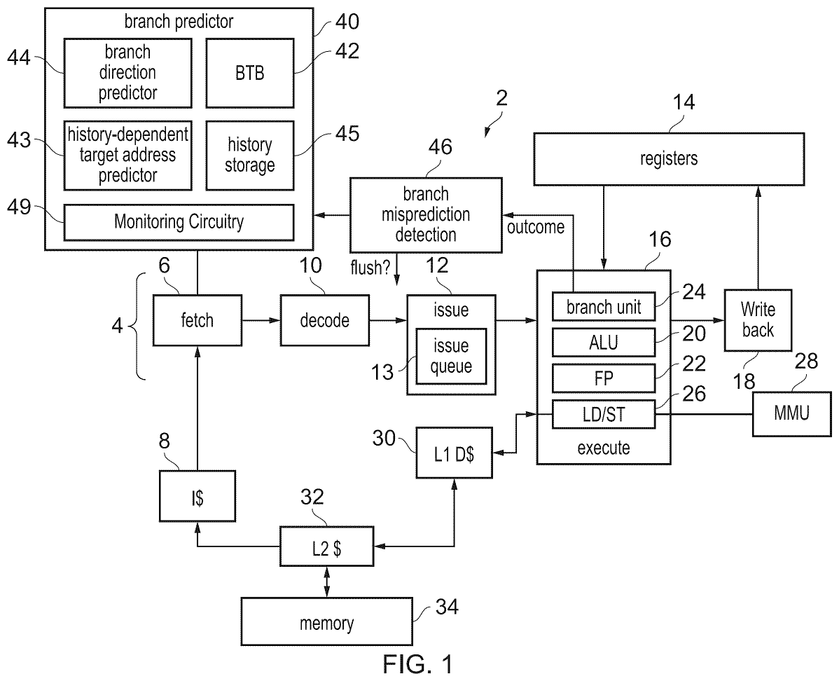

FIG. 1 schematically illustrates an example of a data processing apparatus 2 in accordance with one example implementation. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; an issue stage 12 for queueing micro-operations in an issue queue 13 and checking whether operands required for the micro-operations are available in a register file 14 and issuing micro-operations for execution once the required operands for a given micro-operation are determined to be available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of a possible pipeline architecture, and other systems may have additional stages or a different configuration of stages. For example, in an out-of-order processor a register renaming stage could be included, e.g. between the decode stage 10 and issue stage 12, for mapping architectural registers specified by program instructions or micro-operations to physical register specifiers identifying physical registers in the register file 14. Also, for an out-of-order processor, the writeback stage 18 may use a reorder buffer to track completion of instructions executed out-of-order.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34. A memory management unit (MMU) 28 may be provided to perform memory management operations such as address translation and checking of memory access permissions. The address translation mappings and access permissions may be defined in page table structures stored in the memory system. Information from the page table structures can be cached in a translation lookaside buffer (TLB) provided in the MMU 28.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness. The fetch stage 6 and decode stage 10 may be considered as an example of front end circuitry for supplying micro-operations for processing by the execute stage 16. The execute stage 16 (or alternatively, the pipeline 4 as a whole) can be regarded as an example of processing circuitry for performing processing operations.

As shown in FIG. 1, the apparatus 2 includes a branch predictor 40 for predicting outcomes of branch instructions. The branch predictor is looked up based on addresses of instructions to be fetched by the fetch stage 6 and provides a prediction of whether those instructions are predicted to include branch instructions, e.g. instructions capable of causing a non-sequential change in program flow (a change of program flow other than a sequential transition from one instruction address to the immediately following instruction address in a memory address space). For any predicted branch instructions, the branch predictor 40 provides a prediction of their branch properties such as a branch type, branch target address and branch direction (the branch direction indicating whether the branch is predicted to be taken or not taken). The branch predictor 40 includes a branch target buffer (BTB) 42 (also referred to herein as default prediction circuitry) for predicting properties of the branches other than branch direction, a branch direction predictor (BDP) 44 for predicting the not taken/taken outcome (branch direction), a history-dependent target address predictor 43 (also referred to herein as further prediction circuitry) for predicting branch target addresses for harder-to-predict branches (referred to herein as polymorphic branches) whose target address depends on program flow history of instructions prior to the branch, and history storage circuitry 45 which stores history information indicative of the program flow history. The branch predictor 40 also includes monitoring circuitry 49 which can be used in the manner discussed earlier to monitor an observed indication of the target address for multiple occurrences of certain branch instructions, in particular a branch instruction for which the history-dependent target address predictor 43 is being used to predict branch target addresses, and to determine when it may be beneficial to update the default prediction that will be generated by the default prediction circuitry for such a branch instruction.

It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

Branch misprediction detection circuitry 46 detects, based on outcomes of branch instructions executed by the branch unit 24 of the processing circuitry 4, 16, whether a branch has been incorrectly predicted, and controls the pipeline 4 to suppress effects of the incorrectly predicted branch instruction and cause execution of instructions to resume based on the correct branch outcome (e.g. by flushing operations that are younger than the branch in program order and resuming fetching from the instruction that should be executed after the branch). The prediction state data in the BTB 42, branch direction predictor 44 and history-dependent target address predictor 43 is trained based on the outcomes of executed branch instructions detected by branch misprediction detection circuitry 46. While FIG. 1 shows the branch misprediction detection circuitry 46 as separate from the branch unit 24, execute stage 16 and branch predictor 40, in other examples the branch misprediction detection circuitry 46 could be regarded as part of the processing circuitry 4, 16 or part of the branch prediction circuitry 40.

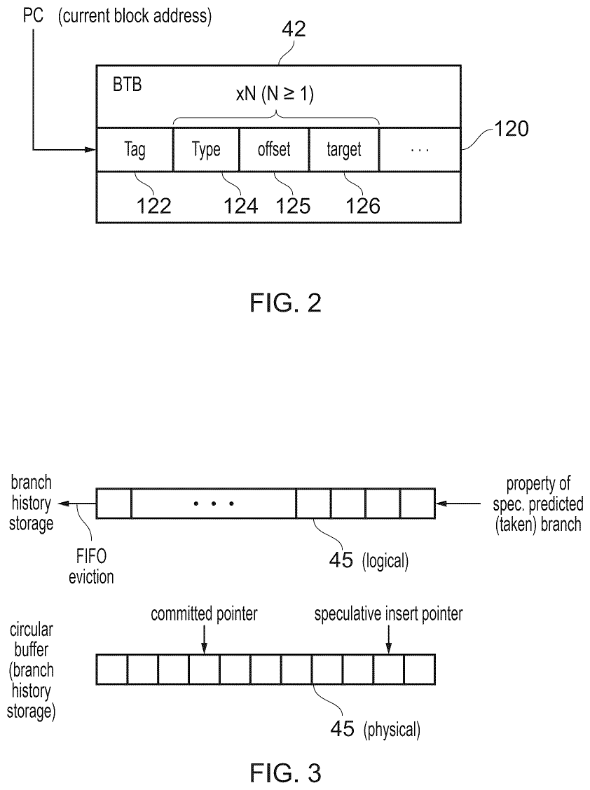

FIG. 2 illustrates an example of the BTB 42, which is a specific example of a history-independent branch target address predictor. The BTB 42 is implemented as a cache-like structure comprising a number of prediction entries 120 able to be allocated for respective addresses. The entries 120 are looked up based on a program counter (PC) address representing the current point in program flow for which a branch prediction is to be generated, in one example implementation this being the address of a current block of one or more instructions for which the prediction lookup is to be made. In many modern processors, the BTB 42 is looked up for a block of instructions at a time, so the program counter may represent the first instruction in the looked up block. For example, the program counter may be the address of a block of instructions determined to be fetched by the fetch stage 6 and the branch predictor may be looked up to identify whether that block of instructions will contain any branches, so that the address of the next block of fetched instructions can be predicted.

Each prediction entry 120 specifies an address tag value 122 used on lookups to the BTB 42 to determine whether that prediction entry 120 relates to the PC address supplied for the BTB lookup. For example, a tag value generated based on a portion of the PC address or as a hash of the PC address may be compared with the tag 122 of a given subset of prediction entries (e.g. the given subset of prediction entries may comprise all of the prediction entries 120, or a limited subset of prediction entries in a set-associative approach). If one of those entries has a tag 122 matching the tag value generated from the input PC address, then a hit is detected in the BTB and a branch prediction can be generated based on contents of the prediction entry 120 (referred to as the “hit prediction entry”) that had the matching tag value 122. If none of the looked up subset of prediction entries 120 has a matching tag value 122 corresponding to the input PC address then a miss is detected and the instruction at the target address is predicted to not require any taken branch, and so instruction fetching may resume sequentially beyond that PC address.

If a hit is detected in the BTB 42, then the hit prediction entry provides a number of other items of prediction state. In the example shown in FIG. 2, these include a predicted branch type 124 (which could for example indicate whether the branch is a conditional branch, a non-conditional branch, a polymorphic branch, or other branch types), a branch offset 125 which indicates an offset of the instruction address of the branch relative to the instruction address of the first instruction in the current block, and a branch target address 126 predicted to be the address of the instruction to which the branch would redirect program execution if the branch was taken. As shown in FIG. 2, it is possible for the BTB entry to include more than one set of branch properties, to predict properties of two or more branches in the same block.

As noted earlier, the branch type field 124 may indicate, as the predicted branch type for a given address corresponding to the prediction entry 120, one of a set of branch types corresponding to different methods taken by the branch predictor 40 for generating the branch prediction for the given address. For example, the branch type field 124 may distinguish the following branch types:
unconditional branch: the branch is always taken, but its target address is predicted based on the target address field 126 of the corresponding prediction entry 120;
conditional branch: whether the branch is predicted taken or not-taken depends on a lookup of the branch direction predictor 44, and if taken the target address of the branch is predicted based on the address specified by the target address field 126;
polymorphic branch: whether the branch is predicted taken or not-taken depends on a lookup of the branch direction predictor 44, and if taken the target address of the branch is predicted based on a history-dependent lookup of the history-dependent branch target address predictor 43. Switching from unconditional/conditional branch type to the polymorphic branch type may be based on a misprediction counter or on a chance-dependent test being applied on detecting a branch misprediction for the unconditional/conditional branch type. Hence, if the BTB 42 is not producing a reliable target address prediction for a branch instruction initially designated as being of the unconditional/conditional branch type, then the type of that branch instruction may be changed to indicate that branch instruction as being a polymorphic branch. In some examples, separate conditional and unconditional variants of the polymorphic branch type may be supported, which differ in terms of whether they require a lookup of the branch direction predictor 44 to predict taken/not-taken outcome, but which both use a lookup of the history-dependent branch target address predictor 43 to predict the target address.

It will be appreciated that other branch types could also be supported. For example, a return branch type could trigger prediction of a return branch address based on a call-return stack structure, a loop terminating branch type could trigger prediction of whether a current iteration of a loop terminating branch instruction terminates a loop based on a dedicated loop termination predictor, etc.

Once a branch has been marked as a polymorphic branch within the BTB 42, then the history-dependent target address predictor 43 can be trained to provide a target address prediction for that polymorphic branch. However, it may take several clock cycles for the history-dependent target address predictor 43 to generate a target address prediction, and in the intervening period the prediction of the target address as provided by the BTB entry 42 can be used.

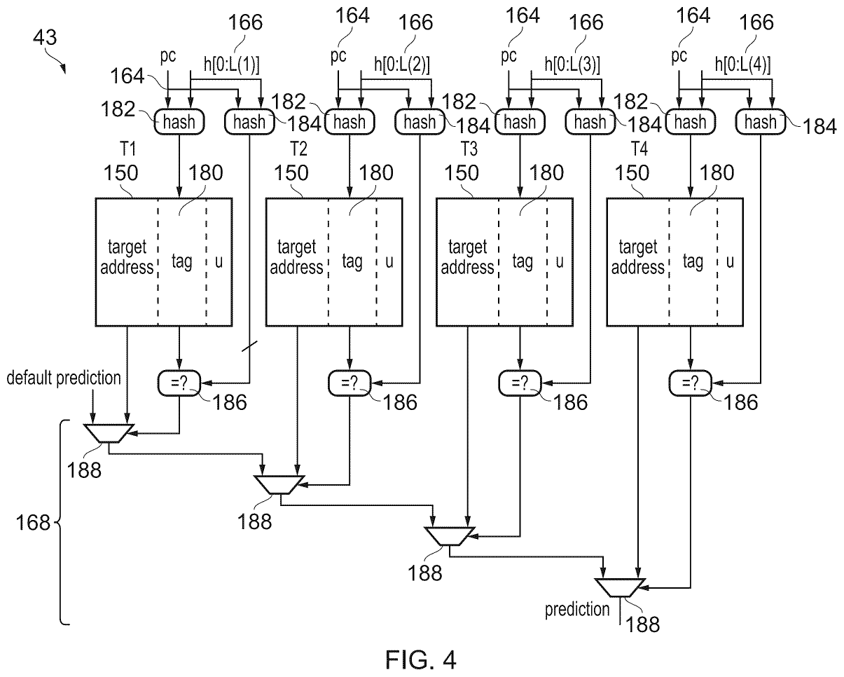

FIG. 3 illustrates an example of the history storage 45. The upper part of FIG. 3 shows a logical view of the history information contained by the history storage. Logically, the history information may be maintained as a FIFO (first-in, first out) buffer, where a certain number of elements of program flow history are maintained, and when an update is made to the history information, a property of a speculatively predicted taken branch is shifted in as a new element at one end of the buffer, causing all the existing elements to shift up one position and the oldest elements to be discarded. For example, the property shifted in to the history buffer could be a value derived from at least one of the program counter address and branch target address for the taken branch. For example, a hash function may be applied to the program counter address and/or branch target address for the taken branch, to derive the value shifted into the history information. Hence, the branch history information stored in history storage 45 may provide a sequential record of the most recent N taken branches in the program flow encountered before the current point of program flow whose address is being input to the branch predictor 40 to generate a latest branch prediction. Other examples could also shift properties of non-taken branches into the history storage. In this case, the property could be an indication of whether the branch is taken or not-taken. Note that the history information maintained by history storage 45 depends on the order in which the corresponding branches are encountered. The same branches occurring in a different order may cause different values of the history information to be maintained by history storage circuitry 45.

As shown in the lower part of FIG. 3, while some examples could implement the physical storage for the history storage circuitry 45 as an actual shift register in which an insertion of a new element into the history storage 45 causes physical shifting elements of the history information up one position, other examples can implement the physical storage for the history storage circuitry 45 as a circular buffer in which the elements stored in the history buffer 45 remain at static positions even when new elements are inserted, but a “speculative insert pointer” is used to track the point of the buffer at which the next element should be inserted when a branch prediction is made. When a new element is inserted into the buffer, it is inserted at a position determined based on the speculative insert pointer, and the speculative insert pointer is updated to advance to the next location of the buffer (wrapping around to the beginning of the buffer if the previous entry identified by the speculative insert pointer was at the end of the buffer). Similarly, a “committed pointer” may track the point of the buffer corresponding to the point of program flow for which all previous processing is known to be correct following resolution of earlier branch outcomes. When the branch unit 24 resolves a branch outcome for a given instruction for which a previous branch prediction was made, if the prediction was correct then the previous speculative update to the history information can be committed, by advancing the committed pointer to point to the next entry (again, wrapping around to the beginning of the buffer when necessary). If the prediction was incorrect then one or more previous speculative updates to the history information can be reversed, e.g. by rewinding the speculative insert pointer to be equal to the committed pointer, or if backup “restoration values” of the speculative insert pointer at given points of program flow were captured, by setting the speculative insert pointer to the one of those restoration values which corresponds to a point of program flow before the point of program flow at which the misprediction occurred.

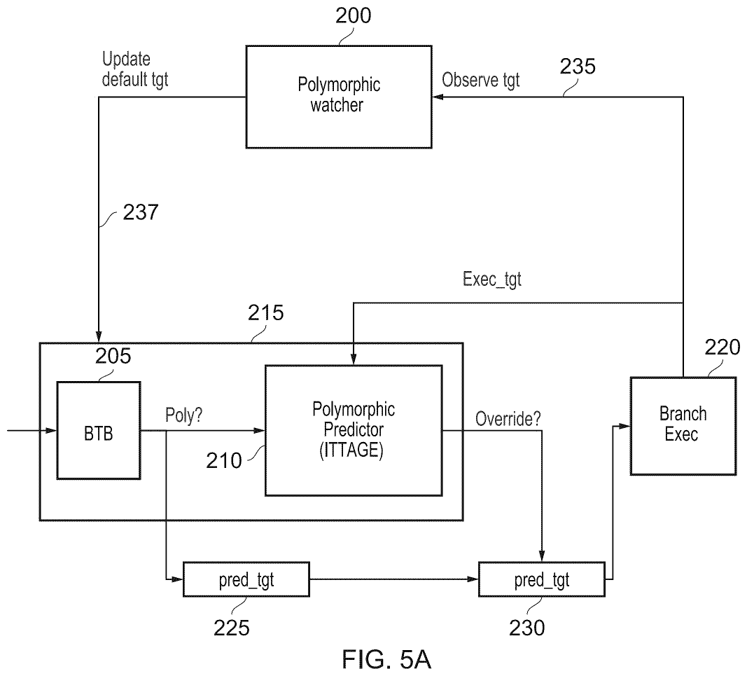

FIG. 4 illustrates an example of the history-dependent target address predictor 43, which in this example has a TAGE (TAgged-GEometric) structure, with a number of TAGE tables (T1 to T4) 150 looked up based on successively increasing lengths of history information. While this example shows four TAGE tables for conciseness, it will be appreciated that TAGE predictors could be provided with a larger number of tables if desired, e.g. 8 or 16. The TAGE tables T1 to T4 are looked up based on the PC 164 and successively increasing lengths of history information 166, so that T1 uses a shorter sequence of history information compared to T2, T2 uses a shorter sequence of history information compared to T3, and so on. For example, table T1 may use the most recent entries 0 to L(1) from the history storage 45, table T2 may use the most recent entries 0 to L(2) from the history storage (where L(2) is an entry allocated to history storage 45 less recently than entry L(1)), and so on. In this example T4 is the table which uses the longest sequence of history information. Each prediction entry specifies a predicted target address, and also specifies a tag value 180 which is compared with a tag hash generated from the program counter 164 and history information 166 to detect whether the entry corresponds to the current block being looked up (the tag distinguishes between multiple blocks whose index hash values alias onto the same entry of the table). The lookup circuitry includes index hashing circuitry 182 for generating an index hash used to select one or more selected entries of the table, tag hashing circuitry 184 for generating a tag hash value to be written to a newly allocated entry or for comparing with an existing entry's tag value 180 on a lookup, and comparison circuitry 186 for comparing the tag value 180 read out from one or more looked up entries with the calculated tag hash generated by the tag hashing circuitry 184 to determine whether a hit has been detected.

Each prediction entry of the history-dependent target address predictor 43 may also have a usefulness value (u) used for controlling replacement of prediction entries (e.g. the usefulness value of a given entry may be reset to an initial value when a hit is detected against that entry or when the entry is first allocated, and the usefulness values of all entries in a given table may be incremented in response to a miss in that table or on an allocation of a new entry, so that over time the usefulness values may distinguish more frequently used entries from less frequently used entries).

For a TAGE predictor, TAGE prediction generating circuitry 168 comprises a cascaded sequence of selection multiplexers 188 which select between the alternative predictions returned by any of the prediction tables 150 which generate a hit. The cascaded multiplexers are such that if the table T4 indexed with the longest sequence of history generates a hit then its prediction will be output as the prediction result, but if it misses then if the preceding table T3 generates a hit then the T3 prediction will be output as the overall prediction for the current block, and so on, so that the prediction which gets selected is the prediction output by the table (among those tables which generated a hit) which corresponds to the longest sequence of history considered in the indexing. That is, any tables which miss are excluded from the selection, and among the remaining tables the one with the longest sequence of history in its indexing information is selected. A default prediction for the target address may be supplied by TAGE prediction generating circuitry in the case when the lookup misses in all the TAGE tables T1-T4 (in practice that scenario should not occur since if none of the tables T1-T4 of history-dependent target address predictor 43 had been configured with relevant information for a given address then the type field 124 in the corresponding BTB entry 120 for the given address should not have been set to a branch type which would cause a lookup to the history-dependent target address predictor 43).

The above approach is extremely useful for providing high performance because a single table indexed with a fixed length of branch history has to trade off the accuracy of predictions against the likelihood of lookups hitting in the table. A table indexed with a relatively short sequence of branch history may be more likely to generate a hit, because it is more likely that the recently seen history leading to the current block is the same as a previously seen sequence of history for which an entry is recorded in the table, but as the shorter sequence of history cannot distinguish as precisely between the different routes by which the program flow may have reached the current block, it is more likely that the prediction indicated in the hit entry may be incorrect. On the other hand, for the table T4 which is indexed based on the longest sequence of history, this can be extremely useful for predicting harder to predict branches which need to delve further into the past in terms of exploring the history so that that the pattern of program execution which led to that branch can be characterised and an accurate prediction made. However, it is less likely on subsequent occasions that the longer sequence of history will exactly match the sequence of history leading up to the current block and so the hit rate is lower in a table indexed based on a longer sequence of history. By providing a range of tables with different lengths of history used for indexing, this can balance these factors so that while the hardest to predict branches which would be difficult to predict using other branch predictors can be successfully predicted with the longer table T4, other easier to predict branches which do not require the full prediction capability of T4 can be predicted using one of the earlier tables indexed based on shorter history so that it is more likely that a hit will be detected on a prediction lookup, thus increasing the percentage of branches for which a successful prediction can be made and therefore improving prediction accuracy and performance. Hence, TAGE predictors are one of the most accurate predictors known.

For the TAGE structures shown in FIG. 4, allocation of an entry in a TAGE table looked up based on a longer sequence of history information may be triggered based on misprediction being detected based on an entry in a TAGE table looked up based on a shorter sequence of history information. Hence, the tables looked up based on longest history may relate to addresses for which mispredictions have continued to occur when predictions were attempted using each TAGE table 150 associated with shorter lengths of history.

Whilst the TAGE-based history-dependent target address predictor 43 can be very good at predicting target addresses for hard to predict branch instructions such as polymorphic branch instructions, there is a latency involved in the generation of the target address using that predictor due to the multiple table lookups and the cascaded sequence of multiplexers used to generate the prediction, and indeed the output from the TAGE predictor 43 may only be available several clock cycles after the output from the BTB 42 is available. In the interim, the target address as predicted by the relevant BTB entry can be used (for instance being used to influence which instructions are next fetched by the fetch circuitry 6) and in the event the target address prediction from the BTB 42 matches the later available prediction from the TAGE predictor 43, this can hide the latency associated with the generation of the target address prediction from the TAGE predictor 43.

However, when the BTB prediction does not match the prediction from the TAGE predictor 43, the latency associated with the generation of the target address prediction from the TAGE predictor 43 can significantly impact performance. In order to seek to reduce this issue, in accordance with the techniques described herein the earlier-mentioned monitoring circuitry 49 is used to seek to detect scenarios where it may be useful to update the target address that will be generated by the BTB 42 for a given polymorphic branch instruction.

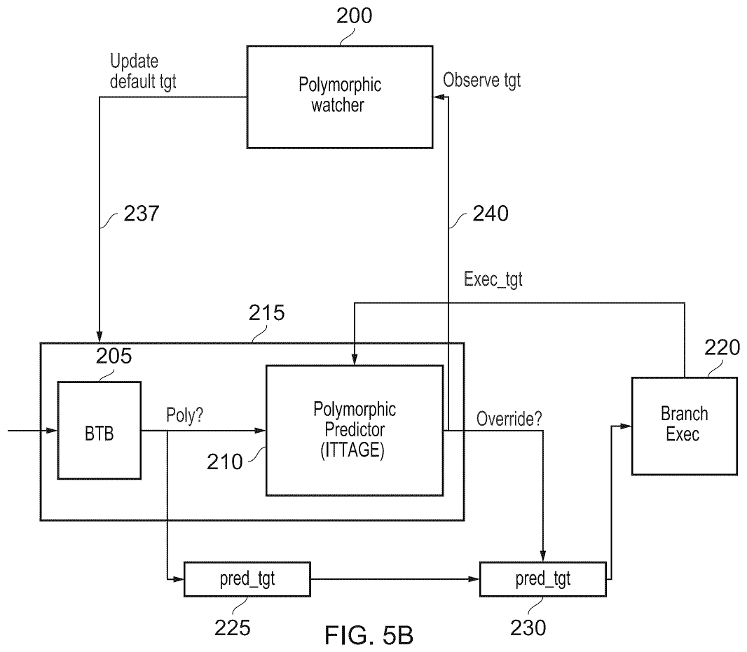

FIG. 5A illustrates one example implementation of how the monitoring circuitry may be used, in the example of FIG. 5A the monitoring circuitry being referred to as a polymorphic watcher 200. In accordance with the techniques discussed earlier, a lookup can be performed within the BTB 205 for a given branch instruction in order to generate a predicted target address 225 for that given branch instruction, referred to herein as the default prediction. As discussed earlier, the BTB entry will also identify the type of the branch instruction, and if the type indicates that the branch instruction is a polymorphic branch, then the history-dependent target address predictor (referred to in FIG. 5A as the polymorphic predictor 210 or ITTAGE predictor (Indirect Target TAGE predictor)) can be accessed to generate a further target address prediction. If that further target address prediction differs from the default target address prediction, then the predicted target address will be updated to match the further target address prediction as indicated by the box 230.

In due course, the branch instruction will be executed as indicated by the box 220, and as a result the actual target address (referred to in FIG. 5A as the Exec_tgt) will be generated, which as shown in FIG. 5A can be returned to the polymorphic predictor 210 to initiate a further training of the relevant entry or entries of the polymorphic predictor. In the example shown in FIG. 5A, this actual target address is also routed over path 235 to the polymorphic watcher 200 to form an observed indication of the target address of the given branch instruction. Based on monitoring this observed indication of the target address for multiple occurrences of the given branch instruction, the polymorphic watcher 200 can detect whether an update condition is considered to be present, the update condition indicating that an update of the default target address generated by the BTB 205 for the given branch instruction may prove useful, for example by increasing the likelihood that the default target address will match the actual execution target address, and/or the target address predicted by the polymorphic predictor 210.

When the polymorphic watcher 200 detects that the update condition is present, it can issue a signal over path 237 to indicate that an update of the default target address generated by the BTB may be useful. This signal could be issued to various components within the branch predictor 40 dependent on implementation, and hence is shown in FIG. 5A as being issued to the generic box 215, which includes both the BTB 205 and the polymorphic predictor 210. The update signal could for example be issued directly to the BTB 205, for instance where the update signal from the polymorphic watcher 200 also identifies the updated default target address that should be stored within the BTB. In another example implementation, the update signal could be issued to the polymorphic predictor 210 to cause the polymorphic predictor to output an updated target address for storing in the BTB 205, for example when the polymorphic predictor next performs a training operation in respect of the branch instruction in question based on the actual target address received as a result of a next execution of that branch instruction.

Whilst in the example of FIG. 5A, each observed indication of the target address reviewed by the monitoring circuitry is an actual target address for the given branch instruction when executed by the processing circuitry, in an alternative implementation as shown in FIG. 5B, the observed target address may in fact be a predicted target address for the given branch instruction as generated by the polymorphic predictor 210, routed to the polymorphic watcher 200 over path 240. When describing the operation of the polymorphic watcher 200 herein to determine when it is considered appropriate to alter the target address prediction generated by the BTB 205 for a polymorphic branch instruction, the observed indication of the target address used by the polymorphic watcher 200 may be either the actual target address following execution, or the predicted target address from the polymorphic predictor 210.

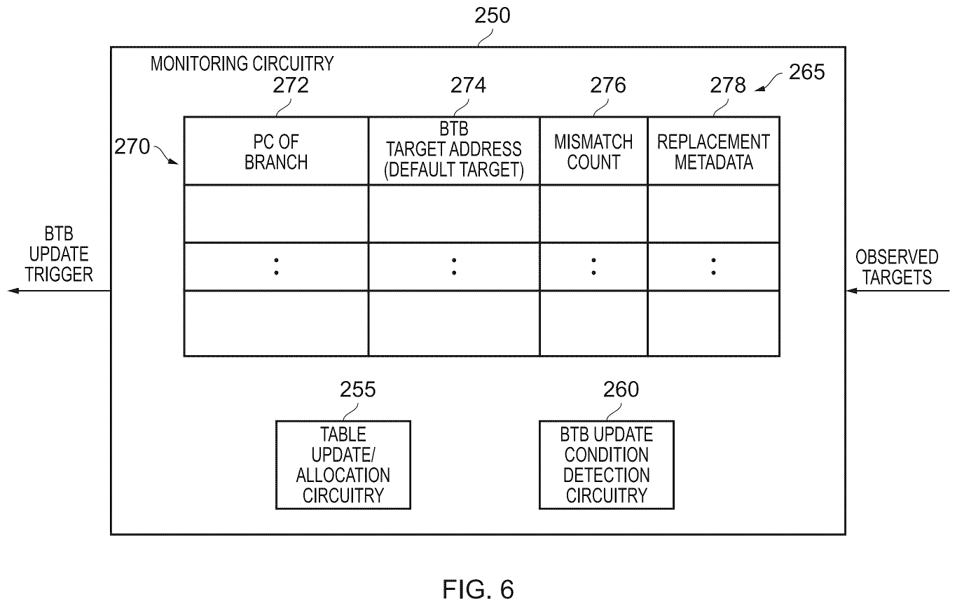

FIG. 6 schematically illustrates one example implementation of the polymorphic watcher 200, referred to in FIG. 6 as the monitoring circuitry 250. The monitoring circuitry 250 maintains a table 265 comprising one or more entries 270, each entry having a number of fields used when tracking a polymorphic branch instruction allocated to that entry. As shown in FIG. 6, an address field 272 is used to identify the address (program counter value) of the branch instruction allocated to the entry, and a target address comparison field 274 is used to maintain a value of the target address against which a subsequent observed indication of the target address is compared. In this example, the target address comparison field is used to store the target address prediction currently produced by the BTB 205 for the branch instruction allocated to the entry 270 of the table 265.

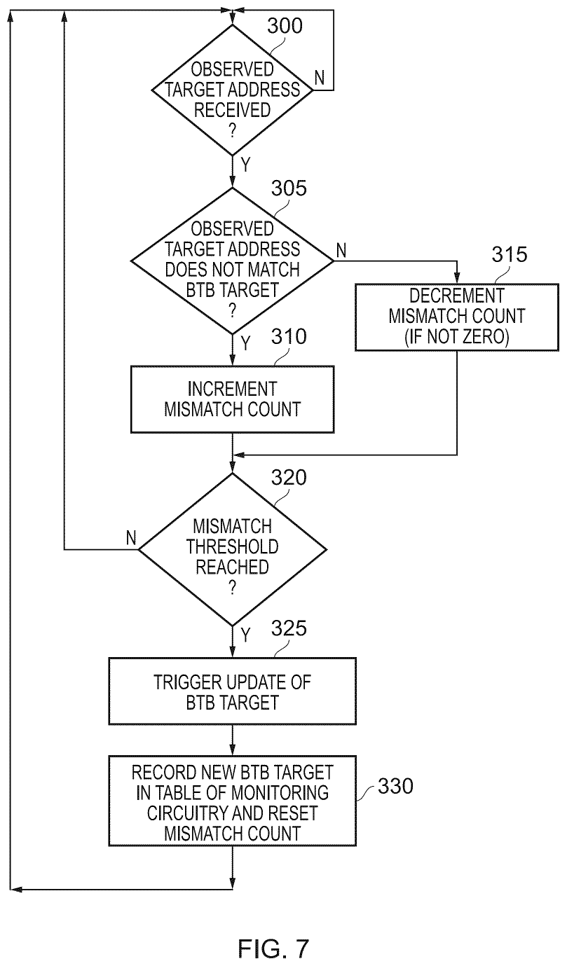

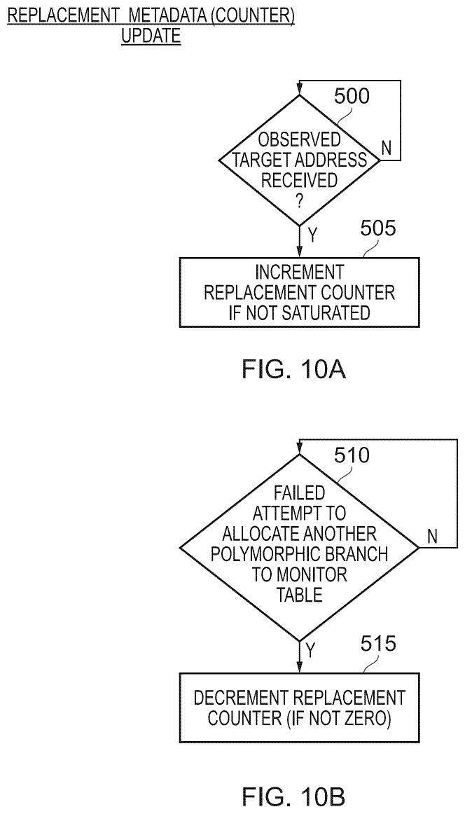

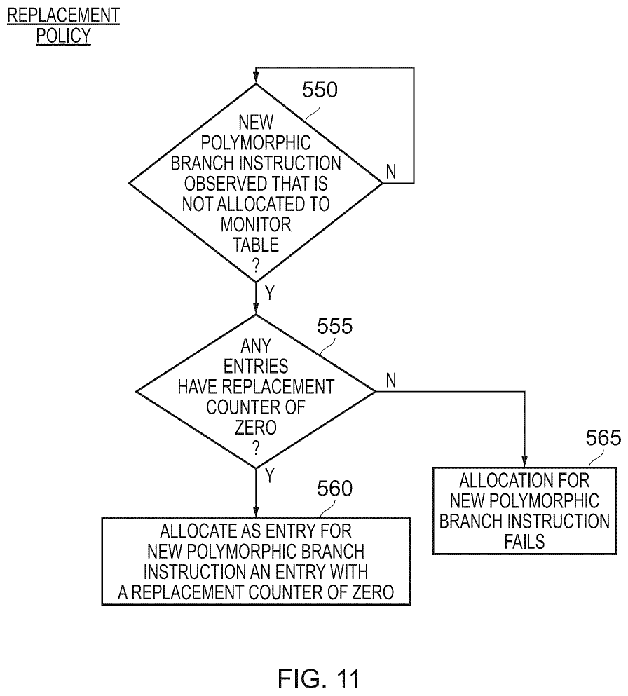

As also shown in FIG. 6, a counter field 276 is provided to maintain a test counter value for the branch instruction allocated to the entry, in this example the test counter being used as a mismatch counter. The technique used in one example implementation to determine adjustment of the test counter value will be discussed in more detail later with reference to the flow diagram of FIG. 7. Each entry 270 also includes a replacement policy field 278 that is used to maintain replacement metadata used by the monitoring circuitry 250 when implementing a replacement policy to determine when the entry is available for reallocation to another polymorphic branch instruction. The approach used to maintain replacement metadata in one example implementation will be discussed later with reference to FIGS. 10A and 10B, and the technique used in one example implementation when deciding whether to allocate a polymorphic branch instruction to an entry of the monitoring circuitry 250 will be described later with reference to FIG. 11.

The monitoring circuitry 250 includes table update and allocation circuitry 255 which is used to allocate polymorphic branch instructions to the one or more entries 270, and following allocation is used to maintain the mismatch counter in field 276 and the replacement metadata in field 278. Also, following a decision to alter the target address generated by the BTB 205, the table update and allocation circuitry 255 will be used to update the field 274 to reflect the updated target address prediction that will then be generated by the BTB, and to reset the mismatch counter upon such an update to the BTB target address prediction. As also shown in FIG. 6, the monitoring circuitry 250 includes BTB update condition detection circuitry 260 which is used to monitor the mismatch counter value 276 within each entry 270 of the table 265, in order to determine whether the mismatch counter value of an entry has reached a predetermined value indicating that a mismatch threshold has been reached, this then indicating that the BTB update condition is considered to be present for the branch instruction being tracked in that entry.

FIG. 7 is a flow diagram illustrating how the monitoring circuitry of FIG. 6 operates, in accordance with one example implementation. At step 300, the monitoring circuitry 250 waits for receipt of an observed target address for a polymorphic branch instruction being tracked within an entry 270 of the table 265. Depending on whether the approach of FIG. 5A or the approach of FIG. 5B is used, this may occur when the branch instruction in question is executed and an actual target address generated, or may occur when the polymorphic predictor 210 generates a predicted target address for the branch instruction in question.

On receipt of an observed target address at step 300, it is determined at step 305 whether the observed target address does not match the BTB target address stored in the field 274 for the branch instruction in question. If it does not match, then at step 310 the mismatch counter is incremented, whereas if the observed target address does match the BTB target address the mismatch counter is decremented at step 315, assuming the mismatch counter is not already 0. In this example implementation it is assumed that the mismatch counter is initialised to 0 when a branch instruction is allocated to an entry, and is then incremented on each observed mismatch and decremented on each observed match. It is also assumed in this example implementation that the magnitude of the increment is the same as the magnitude of the decrement, for example both being a magnitude of 1, but in alternative implementations the magnitude of the decrement may differ to the magnitude of the increment if desired.

At step 320 it is then determined whether a mismatch threshold has been reached, and if not the process returns to step 300 to await receipt of the next observed target address for the branch instruction in question. However, if it is determined at step 320 that the mismatch threshold has been reached, then an update of the BTB target address is triggered at step 325. As discussed earlier, the timing at which the update is triggered may vary dependent on implementation, as may the determination as to the updated target address prediction that should be stored in the relevant entry of the BTB. However, in one example implementation the update is triggered when the branch instruction in question is next executed, and the updated target address may be set to the actual target address generated on execution of the branch instruction, or alternatively may for example be updated to reflect the target address that will be predicted by the polymorphic predictor 210 following the training of that polymorphic predictor based on the actual target address generated on execution of the branch instruction.

At step 330, the updated BTB target address is recorded in the table 265 (more particularly within the field 274 of the relevant entry 270 of the table 265) and the mismatch counter 276 is reset (in the above example implementation this being reset to 0). Thereafter, the process returns to step 300 to await receipt of the next observed target address for the polymorphic branch being tracked in the entry 270 of the table 265.

In one example implementation, in the event that the table 265 comprises multiple entries 270, each of which is used to track a different polymorphic branch instruction, the process of FIG. 7 may be performed for each of the entries. Hence, on receiving an observed target address, the monitoring circuitry can determine whether the branch instruction associated with that observed target address is a branch instruction that is being tracked within an entry of the monitoring circuitry, and if so can then apply the remainder of the process of FIG. 7 with reference to the relevant entry 270 of the table 265.

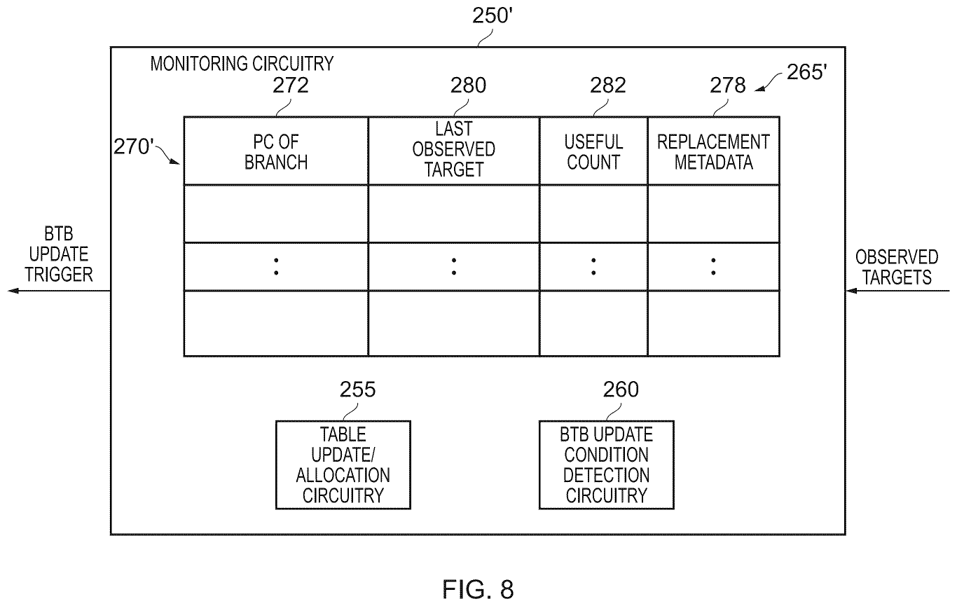

FIG. 8 illustrates an alternative implementation of the polymorphic watcher 200, referred to in FIG. 8 as the monitoring circuitry 250′. As will be apparent from a comparison of FIG. 8 with FIG. 6, the only difference between the monitoring circuitry 250 of FIG. 6 and the monitoring circuitry 250′ of FIG. 8 is in respect of the information maintained within the various fields of the table. In the example of FIG. 8, the table 265′ has one or more entries 270′, each entry including an address field 272 to identify the program counter value of a polymorphic branch instruction allocated to that entry, and a replacement policy field 278 used to maintain replacement metadata, in the same way as the entries 270 of the table 265 of the monitoring circuitry 250 of FIG. 6. However, in FIG. 8, the target address comparison field 280 is used to identify the last target address observed by the monitoring circuitry for the branch instruction in question rather than the current BTB target address. Further, the counter field 282 is used to maintain a useful count value providing an indication of how useful the last observed target is in predicting the next observed target.

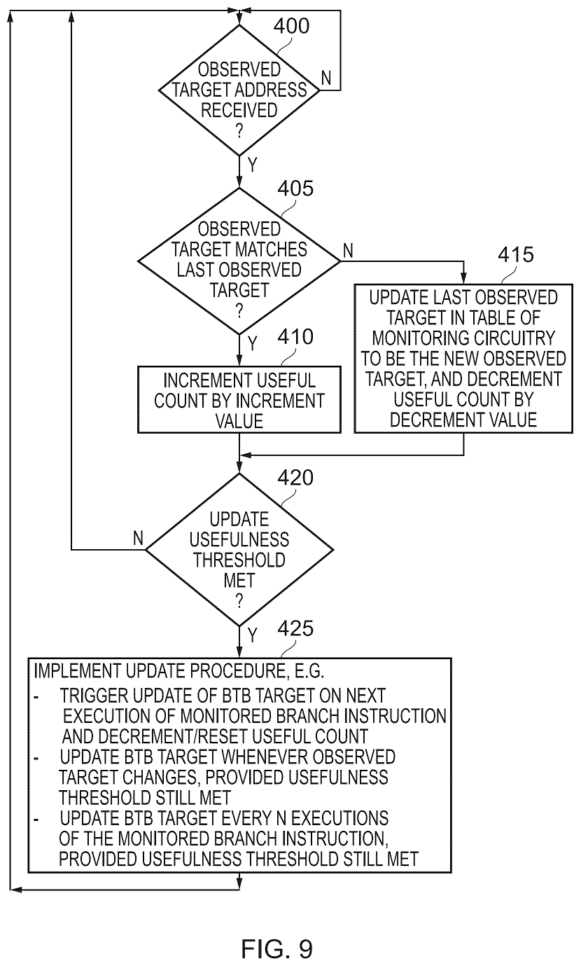

FIG. 9 is a flow diagram illustrating how the monitoring circuitry of FIG. 8 operates, in accordance with one example implementation. At step 400, the monitoring circuitry 250′ waits for receipt of an observed target address for a polymorphic branch instruction being tracked within an entry 270′ of the table 265′. As noted earlier, this may occur when the branch instruction in question is executed and an actual target address generated, or may occur when the polymorphic predictor 210 generates a predicted target address for the branch instruction in question.

On receipt of an observed target address at step 400, it is determined at step 405 whether the observed target address matches the last observed target address as stored within the field 280. If it does, then the useful count is incremented by an increment value at step 410, but if the observed target does not match the last observed target then instead at step 415 the last observed target field 280 is updated to indicate the new observed target address, and in addition the useful count is decremented by a decrement value. Whilst the increment value used at step 410 may be of the same magnitude as the decrement value used at step 415, this is not essential, and in some implementations it may be considered appropriate to have a decrement value that is of a different magnitude to the increment value.

At step 420, it is determined with reference to the useful count value in the field 282 whether an update usefulness threshold has been met. If not, the process returns to step 400 to await receipt of the next observed target address for the branch instruction in question. However, if it is determined at step 420 that the update usefulness threshold has been met, then the process proceeds to step 425 where an update procedure is implemented. This update procedure can take a variety of forms. In one example implementation it may involve triggering an update of the BTB target address on a next execution of the monitored branch instruction, followed by a decrement of the useful count by a predetermined amount, or the resetting of that useful count to an initial value, for example a 0 value.

Whilst in the illustrated example of FIG. 9, the update of the BTB target address may occur on the next execution of the monitored branch instruction, this is not a requirement and the update could instead be triggered at a different point. For instance, it could be triggered immediately on detecting the threshold being met, for example causing the BTB target address prediction to be updated to match the current observed indication of the target address. Further, even when considering the next execution of the monitored branch instruction, the actual time at which the update is triggered may vary dependent on how the monitoring circuitry 250′ is arranged to observe the next execution. For example, the update may be triggered the next time the monitored branch instruction is executed by the processing pipeline, the next time the result of execution of that monitored branch instruction is committed, the next time a prediction of the target address is made for that monitored branch instruction, etc.

There are also various ways in which the updated target address prediction to be generated by the BTB may be determined. It could for example be set based on the current observed indication of the target address as being tracked at the point the update usefulness threshold was detected, or could alternatively be updated based on the next observed indication of the target address following detection of the update usefulness threshold being met. Further, it could be set to match an actual target address determined during execution of the branch instruction in question, or could be set to match a predicted value of the target address generated by the polymorphic predictor 210. In one example implementation, a check may be performed prior to updating the BTB, to determine whether the updated target address prediction generated in the above manner does in fact differ to the currently stored BTB target address prediction, and to only initiate the update of the BTB if it does. Such an approach can save power consumption by avoiding any unnecessary updates.

As indicated in FIG. 9, whilst the above is one example of the update procedure that could be implemented at step 425, there are various other alternative approaches that could be taken. In particular, the presence of the update usefulness threshold may not merely trigger a single update of the BTB target address prediction, but instead periodic updates to the BTB target address prediction may occur whilst the update usefulness threshold is determined to continue to be met or exceeded. In particular, in one example implementation, whilst the update usefulness threshold is determined to be met or exceeded, the monitoring circuitry may be arranged to implement an update procedure comprising one of:
causing the BTB to be updated such that the BTB target address prediction is altered whenever the monitoring circuitry detects a change in the observed indication of the target address;
causing the BTB to be updated such that the BTB target address prediction is altered once every N executions of the branch instruction in question.

In one example implementation of the above approach, the value of the useful counter can continue to be updated (incremented and decremented) in the manner discussed earlier based on further observed indications of the target address, and the above update process can continue until such time that the useful counter value is adjusted to a value that indicates that the update usefulness threshold is no longer met.

As shown in FIG. 9, following step 425, the process returns to step 400 to await receipt of the next observed target address for the branch instruction in question. As with the earlier discussed example of FIG. 6, in the event that the table 265′ comprises multiple entries 270′, each of which is used to track a different polymorphic branch instruction, the process of FIG. 9 may be performed for each of the entries. Hence, on receiving an observed target address, the monitoring circuitry can determine whether the branch instruction associated with that observed target address is for a branch instruction that is being tracked within an entry of the monitoring circuitry, and if so can then apply the remainder of the process of FIG. 9 with reference to the relevant entry 270′ of the table 265′.

FIGS. 10A and 10B illustrate how replacement metadata within an entry of the monitoring circuitry may be updated, in accordance with one example implementation. In this example, it is assumed that on allocation of a polymorphic branch instruction to an entry, the replacement metadata takes the form of a replacement counter that is initialised to 0. As shown in FIG. 10A, if at step 500 an observed target address is received for the branch instruction being tracked in the corresponding entry (due for example to an instance of that branch instruction being executed), then the replacement counter is incremented at step 505 provided it is not yet at a maximum/saturated value.

As shown in FIG. 10B, if the monitoring circuitry observes a target address for a polymorphic branch instruction that is not yet allocated to an entry of its table, then it may seek to allocate an entry for that polymorphic branch instruction, for example using the process that will be discussed later with reference to FIG. 11. However, if the attempt to allocate another polymorphic branch instruction to the table of the monitoring circuitry fails at step 510, then the replacement counter of all currently active entries within the table are decremented, provided they are not already 0. In one example implementation, the magnitude of the increment applied at step 505 and the magnitude of the decrement applied at step 515 are the same, but in alternative implementations they may differ.

FIG. 11 is a flow diagram illustrating an example replacement policy that may be employed by the monitoring circuitry, in accordance with one example implementation. At step 550, it is determined whether a new polymorphic branch instruction is observed by the monitoring circuitry that is not yet allocated to an entry of the table of the monitoring circuitry. For example, the monitoring circuitry may observe a target address for a particular polymorphic branch instruction, and determine that that particular polymorphic branch instruction is not currently being tracked by the monitoring circuitry.

When at step 550 such a new polymorphic branch instruction is observed, it is then determined at step 555 whether there are any entries that have a replacement counter of zero. If not, the process proceeds to step 565 where allocation for the new polymorphic branch instruction fails, triggering the decrement of the replacement counters of all the active entries at step 515 of FIG. 10B. However, if there is at least one entry that has a replacement counter of zero, then at step 560 one of those entries that has a replacement counter of zero can be chosen as a victim entry in which to allocate the new polymorphic branch instruction. At this point, the current contents of that entry are discarded, and the table update/allocation circuitry 255 of the monitoring circuitry is used to populate the various fields of the allocated entry so as to track the new polymorphic branch instruction.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

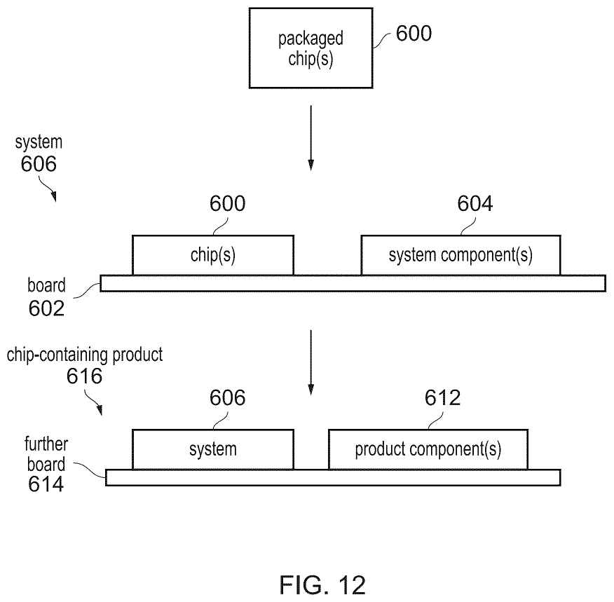

As shown in FIG. 12, one or more packaged chips 600, with the apparatus described above implemented on one chip or distributed over two or more of the chips, are manufactured by a semiconductor chip manufacturer. In some examples, the chip product 600 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 600 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips combined to provide the functionality of a single chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 600 are assembled on a board 602 together with at least one system component 604 to provide a system 606. For example, the board may comprise a printed circuit board. The board substrate may be made of any of a variety of materials, e.g. plastic, glass, ceramic, or a flexible substrate material such as paper, plastic or textile material. The at least one system component 604 comprise one or more external components which are not part of the one or more packaged chip(s) 600. For example, the at least one system component 604 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 616 is manufactured comprising the system 606 (including the board 602, the one or more chips 600 and the at least one system component 604) and one or more product components 612. The product components 612 comprise one or more further components which are not part of the system 606. As a non-exhaustive list of examples, the one or more product components 612 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 606 and one or more product components 612 may be assembled on to a further board 614.

The board 602 or the further board 614 may be provided on or within a device housing or other structural support (e.g. a frame or blade) to provide a product which can be handled by a user and/or is intended for operational use by a person or company.

The system 606 or the chip-containing product 616 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc.

An integrated circuit fabricated using the computer-readable code may comprise components such as one or more of a central processing unit, graphics processing unit, neural processing unit, digital signal processor or other components that individually or collectively embody the concept.

Some example configurations are set out in the following numbered clauses:
1. An apparatus comprising:
   default prediction circuitry, responsive to an address associated with a given branch instruction, to generate a default prediction of a target address for the given branch instruction;
   further prediction circuitry arranged, when the given branch instruction is a given type of branch instruction, to generate a further prediction of the target address for the given branch instruction, wherein the further prediction is generated later than the default prediction and is used in place of the default prediction in the event that the further prediction differs from the default prediction; and
   monitoring circuitry responsive to detecting an update condition based on monitoring an observed indication of the target address for multiple occurrences of the given branch instruction, to cause the default prediction circuitry to be updated so as to alter the default prediction generated by the default prediction circuitry for the given branch instruction.
2. An apparatus as in Clause 1, wherein:
   the further prediction circuitry is a history-dependent prediction circuitry that is arranged to generate the further prediction in dependence on a program flow history of a program executed by processing circuitry; and
   the given type of branch instruction is a polymorphic branch instruction whose target address varies in dependence on the program flow history.
3. An apparatus as in Clause 1 or Clause 2, wherein the monitoring circuitry is arranged to detect the update condition based on performance of a probabilistic test to assess, given the observed indication of the target address for multiple occurrences of the given branch instruction, whether an update of the default prediction is expected to improve accuracy of the default prediction.
4. An apparatus as in Clause 3, wherein the monitoring circuitry is arranged to maintain a test counter for the given branch instruction, whose value is altered in dependence on the observed indication of the target address for multiple occurrences of the given branch instruction, and the probabilistic test comprises determining whether the test counter has at least reached a predetermined value indicating presence of the update condition.
5. An apparatus as in Clause 4, wherein the monitoring circuitry is arranged, for the given branch instruction, to store an indication of the default prediction of the target address generated by the default prediction circuitry, to use the test counter to track occurrences of divergence of the observed indication of the target address from the default prediction, and to detect the update condition when the test counter reaches the predetermined value indicating that a mismatch threshold has been reached.
6. An apparatus as in Clause 5, wherein each time the observed indication of the target address for an occurrence of the given branch instruction differs from the default prediction the monitoring circuitry is arranged to increment the test counter by an increment value.
7. An apparatus as in Clause 6, wherein each time the observed indication of the target address for an occurrence of the given branch instruction matches the default prediction the monitoring circuitry is arranged to decrement the test counter by a decrement value.
8. An apparatus as in any of clauses 5 to 7, wherein the monitoring circuitry is arranged, on determining that the mismatch threshold has been reached, to trigger an update of the default prediction circuitry such that an altered default prediction will be generated, to update the stored indication of the default prediction to match the altered default prediction, to reset the test counter, and to then track occurrences of divergence of the observed indication of the target address from the altered default prediction.
9. An apparatus as in Clause 4, wherein the monitoring circuitry is arranged, for the given branch instruction, to maintain a record of a last observed indication of the target address, to use the test counter to track when a current observed indication of the target address matches the last observed indication, and to detect the update condition when the test counter at least reaches the predetermined value indicating that an update usefulness threshold has been met.
10. An apparatus as in Clause 9, wherein each time the current observed indication of the target address matches the last observed indication of the target address the monitoring circuitry is arranged to increment the test counter by an increment value.
11. An apparatus as in Clause 10, wherein each time the current observed indication of the target address differs to the last observed indication of the target address, the monitoring circuitry is arranged to decrement the test counter by a decrement value and to update the record of the last observed indication of the target address to indicate the current observed indication.
12. An apparatus as in any of clauses 9 to 11, wherein the monitoring circuitry is arranged, responsive to determining that the update usefulness threshold has been met, to cause an update of the default prediction circuitry such that an altered default prediction will be generated, and to apply an adjustment to the test counter value.
13. An apparatus as in any of clauses 9 to 11, wherein whilst the update condition is determined to be present, the monitoring circuitry is arranged to implement an update procedure comprising one of:
   causing the default prediction circuitry to be updated such that the default prediction is altered whenever the monitoring circuitry detects a change in the observed indication of the target address;
   causing the default prediction circuitry to be updated such that the default prediction is altered once every N executions of the given branch instruction.
14. An apparatus as in any preceding clause, wherein the observed indication of the target address comprises one of:
   the further prediction of the target address for the given branch instruction as generated by the further prediction circuitry;
   an actual target address for the given branch instruction when executed by processing circuitry.
15. An apparatus as in any preceding clause, wherein:
   the monitoring circuitry is arranged to maintain one or more entries, where each entry has an identifier field used to identify a branch instruction of the given type associated with that entry, a counter field used to maintain a test counter value for the branch instruction associated with the entry, and a target address comparison field to maintain a value of the target address against which a subsequent observed indication of the target address is compared in order to determine adjustment of the test counter value; and
   each entry further comprises a replacement policy field used to maintain metadata used by the monitoring circuitry when implementing a replacement policy to determine when the entry is available for reallocation to another branch instruction of the given type, wherein the replacement policy is arranged to bias use of the one or more entries for monitoring of more frequently occurring branch instructions of the given type within a program flow history of a program executed by processing circuitry.
16. An apparatus as in Clause 15, wherein:
   the monitoring circuitry is arranged, for each entry, to maintain a replacement counter in the replacement policy field that is adjusted in a first direction each time the branch instruction associated with that entry is observed by the monitoring circuitry, and is adjusted in a second direction each time the monitoring circuitry, on observing a branch instruction of the given type not yet allocated to an entry of the monitoring circuitry, has no available entry to allocate for that branch instruction; and
   the monitoring circuitry is arranged to identify a given entry as an available entry for allocation when the replacement counter in the replacement policy field of that given entry has a predetermined value.
17. A method of generating predictions of a target address of branch instructions, comprising:
   responsive to an address associated with a given branch instruction, generating using default prediction circuitry a default prediction of a target address for the given branch instruction;
   when the given branch instruction is a given type of branch instruction, generating using further prediction circuitry a further prediction of the target address for the given branch instruction, wherein the further prediction is generated later than the default prediction and is used in place of the default prediction in the event that the further prediction differs from the default prediction; and
   responsive to detecting an update condition based on monitoring an observed indication of the target address for multiple occurrences of the given branch instruction, causing the default prediction circuitry to be updated so as to alter the default prediction generated by the default prediction circuitry for the given branch instruction.
18. A system comprising:
   the apparatus of any of clauses 1 to 16, implemented in at least one packaged chip;
   at least one system component; and
   a board,
wherein the at least one packaged chip and the at least one system component are assembled on the board.
19. A chip-containing product comprising the system of clause 18, wherein the system is assembled on a further board with at least one other product component.
20. A computer-readable medium storing computer-readable code for fabrication of the apparatus of any of clauses 1 to 16.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
default prediction circuitry, responsive to an address associated with a given branch instruction, to generate a default prediction of a target address for the given branch instruction;
further prediction circuitry arranged, when the given branch instruction is a given type of branch instruction, to generate a further prediction of the target address for the given branch instruction, wherein the further prediction is generated later than the default prediction and is used in place of the default prediction in the event that the further prediction differs from the default prediction; and
monitoring circuitry responsive to detecting an update condition based on monitoring an observed indication of the target address for multiple occurrences of the given branch instruction, to cause the default prediction circuitry to be updated so as to alter the default prediction generated by the default prediction circuitry for the given branch instruction.

2. An apparatus as claimed in claim 1, wherein:
the further prediction circuitry is a history-dependent prediction circuitry that is arranged to generate the further prediction in dependence on a program flow history of a program executed by processing circuitry; and
the given type of branch instruction is a polymorphic branch instruction whose target address varies in dependence on the program flow history.

3. An apparatus as claimed in claim 1, wherein the monitoring circuitry is arranged to detect the update condition based on performance of a probabilistic test to assess, given the observed indication of the target address for multiple occurrences of the given branch instruction, whether an update of the default prediction is expected to improve accuracy of the default prediction.

4. An apparatus as claimed in claim 3, wherein the monitoring circuitry is arranged to maintain a test counter for the given branch instruction, whose value is altered in dependence on the observed indication of the target address for multiple occurrences of the given branch instruction, and the probabilistic test comprises determining whether the test counter has at least reached a predetermined value indicating presence of the update condition.

5. An apparatus as claimed in claim 4, wherein the monitoring circuitry is arranged, for the given branch instruction, to store an indication of the default prediction of the target address generated by the default prediction circuitry, to use the test counter to track occurrences of divergence of the observed indication of the target address from the default prediction, and to detect the update condition when the test counter reaches the predetermined value indicating that a mismatch threshold has been reached.

6. An apparatus as claimed in claim 5, wherein each time the observed indication of the target address for an occurrence of the given branch instruction differs from the default prediction the monitoring circuitry is arranged to increment the test counter by an increment value.

7. An apparatus as claimed in claim 6, wherein each time the observed indication of the target address for an occurrence of the given branch instruction matches the default prediction the monitoring circuitry is arranged to decrement the test counter by a decrement value.

8. An apparatus as claimed in claim 5, wherein the monitoring circuitry is arranged, on determining that the mismatch threshold has been reached, to trigger an update of the default prediction circuitry such that an altered default prediction will be generated, to update the stored indication of the default prediction to match the altered default prediction, to reset the test counter, and to then track occurrences of divergence of the observed indication of the target address from the altered default prediction.

9. An apparatus as claimed in claim 4, wherein the monitoring circuitry is arranged, for the given branch instruction, to maintain a record of a last observed indication of the target address, to use the test counter to track when a current observed indication of the target address matches the last observed indication, and to detect the update condition when the test counter at least reaches the predetermined value indicating that an update usefulness threshold has been met.

10. An apparatus as claimed in claim 9, wherein each time the current observed indication of the target address matches the last observed indication of the target address the monitoring circuitry is arranged to increment the test counter by an increment value.

11. An apparatus as claimed in claim 10, wherein each time the current observed indication of the target address differs to the last observed indication of the target address, the monitoring circuitry is arranged to decrement the test counter by a decrement value and to update the record of the last observed indication of the target address to indicate the current observed indication.

12. An apparatus as claimed in claim 9, wherein the monitoring circuitry is arranged, responsive to determining that the update usefulness threshold has been met, to cause an update of the default prediction circuitry such that an altered default prediction will be generated, and to apply an adjustment to the test counter value.

13. An apparatus as claimed in claim 9, wherein whilst the update condition is determined to be present, the monitoring circuitry is arranged to implement an update procedure comprising one of:
causing the default prediction circuitry to be updated such that the default prediction is altered whenever the monitoring circuitry detects a change in the observed indication of the target address;
causing the default prediction circuitry to be updated such that the default prediction is altered once every N executions of the given branch instruction.

14. An apparatus as claimed in claim 1, wherein the observed indication of the target address comprises one of:
the further prediction of the target address for the given branch instruction as generated by the further prediction circuitry;
an actual target address for the given branch instruction when executed by processing circuitry.

15. An apparatus as claimed in claim 1, wherein:
the monitoring circuitry is arranged to maintain one or more entries, where each entry has an identifier field used to identify a branch instruction of the given type associated with that entry, a counter field used to maintain a test counter value for the branch instruction associated with the entry, and a target address comparison field to maintain a value of the target address against which a subsequent observed indication of the target address is compared in order to determine adjustment of the test counter value; and
each entry further comprises a replacement policy field used to maintain metadata used by the monitoring circuitry when implementing a replacement policy to determine when the entry is available for reallocation to another branch instruction of the given type, wherein the replacement policy is arranged to bias use of the one or more entries for monitoring of more frequently occurring branch instructions of the given type within a program flow history of a program executed by processing circuitry.

16. An apparatus as claimed in claim 15, wherein:
the monitoring circuitry is arranged, for each entry, to maintain a replacement counter in the replacement policy field that is adjusted in a first direction each time the branch instruction associated with that entry is observed by the monitoring circuitry, and is adjusted in a second direction each time the monitoring circuitry, on observing a branch instruction of the given type not yet allocated to an entry of the monitoring circuitry, has no available entry to allocate for that branch instruction; and
the monitoring circuitry is arranged to identify a given entry as an available entry for allocation when the replacement counter in the replacement policy field of that given entry has a predetermined value.

17. A method of generating predictions of a target address of branch instructions, comprising:
responsive to an address associated with a given branch instruction, generating using default prediction circuitry a default prediction of a target address for the given branch instruction;
when the given branch instruction is a given type of branch instruction, generating using further prediction circuitry a further prediction of the target address for the given branch instruction, wherein the further prediction is generated later than the default prediction and is used in place of the default prediction in the event that the further prediction differs from the default prediction; and
responsive to detecting an update condition based on monitoring an observed indication of the target address for multiple occurrences of the given branch instruction, causing the default prediction circuitry to be updated so as to alter the default prediction generated by the default prediction circuitry for the given branch instruction.

18. A system comprising:
the apparatus of claim 1, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A computer-readable medium storing computer-readable code for fabrication of the apparatus of claim 1.
